(19) United States
(12) Patent Application Publication
(10) Pub. No.: US 2019/0143753 A1
(43) Pub. Date: May 16, 2019

(54) BALANCED NON-DEFLATABLE VEHICLE TIRE

(71) Applicant: Gameel Gabriel, Covington, LA (US)

(72) Inventor: Gameel Gabriel, Covington, LA (US)

(21) Appl. No.: 15/810,239

(22) Filed: Nov. 13, 2017

(51) Int. Cl. B60C 5/08; B60C 17/04; B60C 17/01; B60C 5/20

(52) U.S. Cl. CPC B60C 5/08; B60C 17/044; B60C 17/043; B60C 5/20; B60C 17/01

(57) ABSTRACT

A balanced non-deflatable vehicle tire providing balanced operation even after partial puncture, adjustment of overall air pressure, use of standard rimmed wheels, and the option of being retrofit into existing tires, by providing alternating layers of puncture-resistant sheet material and pressurized-cell sheets, and an inner-tube to fill the remaining internal space and to adjust and apply balanced pressure internally.

### BACKGROUND

This invention provides a balanced non-deflatable vehicle tire.

An existing vehicle tire might be partially penetrated by a relatively short nail or screw, but not penetrated enough to cause an immediate air leak until after the vehicle is driven for several miles. Each of these additional miles will be forcing nail or screw further into the tire, until it ultimately causes an air leak. Although such a small leak is usually repairable, there is significant inconvenience involved in making the repair. Further, a flat tire may put the occupants of the vehicle in danger when incurred in certain locations, or under certain circumstances. Additionally, continuing to drive on a flat tire for any significant distance is certain to shred and ruin the tire, and is also likely to damage the wheel or rim. This damage is incurred in part because the seal and attachment of the tire to the wheel is completely dependent on the high air pressure in the mounted tire.

Existing vehicle tires that include existing puncture-resisting technology have limitations. Some vehicles with puncture-resistant technology result in a tire that is hard to balance and keep in balance during use, due to movement of the added components inside the tire. Others will go out of balance when an individual internal segment is punctured, even though the tire would remain mostly inflated. Some do not allow for increase or decrease of internal air pressure to adjust for different conditions. And others require the use of a purpose-built tire instead of allowing for the retrofitting of the retrofitting of existing tires.

U.S. Pat. No. 488,061 was issued to inventor William I. Bunker on Dec. 18, 1892, covering an improved “Vehicle Tire.” The '061 patent aims to make a vehicle-tire especially adapted for bicycle wheels, which shall be flexible, and yet held with sufficient tension by mechanical means introduced into the tire. The inventor discloses that his improvement in vehicle-tires is achieved by taking an endless tube, tire, or case of the desired size and strength and filling it wholly or partially with elastic balls that will serve to give the proper expansion to the tube and impart to it the desired tension or resiliency. In some cases, the tire may be filled entirely with balls of a small size, so that a number of them will lie side-by-side in the cross-section of the tube. In other cases, a tire is provided with an inner tube, and, after inflating the space between the inner and the outer tubes with the desired quantity of air, a number of elastic balls or cushions may be introduced into the inner tube to press one side of it toward the air-filled space, thus subjecting the air to the desired amount of pressure to give a tire of the requisite tension. These designs, among others, are further discussed in the '061 patent, incorporating a flexible inclosing case and separate “elastic cushions” (e.g., balls).

U.S. Pat. No. 459,614, as issued on Sep. 15, 1891 to inventor William Richwine, covers an improved “Tire for Bicycles”. The '614 patent discloses a tire, more particularly for bicycles, formed of a tube of elastic material, and air-filled or inflated bodies therein as cushions, with a means for permitting the air to escape from and be returned to said bodies, whereby an easy-riding tire is produced and the same is well sustained in its peripheral direction. Further provided is a means of connecting the elastic tube or tire with a metallic rim, to which all the spokes are attached. The disclosed invention comprises of a tube of soft rubber or other suitable material, curved after the manner of a tire. Within said tube are hollow balls of rubber, and said balls having openings for the education and induction of air. Furthermore, the inner periphery of the tube is formed with a neck that is embraced by a band of metal, whose ends are provided with flanges that rest upon the portion of the tube aside of said neck. The interior of the tube, at what may be called the outer periphery thereof, is formed with pockets in which the balls are seated, so that said balls retain their position.

U.S. Pat. No. 3,831,653 was issued on Aug. 27, 1974 to inventor Alvin Edward Moore, covering a “Puncture-Resistant Tire Assembly.” The disclosed invention of the '653 patent is generally directed to a vehicle tire casing and inner inflated tubular member of material comprising lead (or optionally other highly malleable metal having high ductility in the range of that of lead and copper, and substantially pure aluminum and tin). Lead, which may be flexed many thousands of times without fracture, is resistant to puncture and may be welded by simple heating without flux, is preferred; when copper, aluminum or tin is used the tubular member is sheathed in and flexibly bonded to a thin-rubber envelope. The invention contemplates a doughnut-shaped lead inner tube; but optionally the tubular member comprises annularly arranged tubular elements, each having a middle portion of greatest inflated bulge, from which portions curvingly slope to wider constrictions at ends of the elements. These constrictions may be: flattened, hermetically bonded plies of the tubular member material; or only substantially flat, having lines of seam or spot welding, allowing passage of gas between the welds. The invention includes a wheel, having laterally projecting flanges, inward of which casing flanges are held.

U.S. Pat. No. 3,256,123, as issued on Jun. 14, 1966 to inventor Frank A. Hart, covers an improved “Automobile Tire,” which relates to pneumatic tires and/or tubes for vehicles such as automobiles, trucks, plows, cycles, and the like, and is more particularly directed to an improved tire construction that will substantially reduce the possibility of flats and blowouts in pneumatic tires. More specifically, the '123 patent claims the method of making a pneumatic tire that comprises of taking a plurality of separate elastic elements, each of which is constituted of a resilient material formed to provide a closed chamber, and a gas contained in said chamber, and packaging such elements in carrier means capable of being inserted into the casing of a finished pneumatic tire having an inner tube opening. The method of making such is further discussed in the '123 patent.

U.S. Pat. No. 1,332,953 was issued on Mar. 9, 1920 to inventor William H. Richards, covering an improved “Pneumatic Tire.” The material of the '953 patent relates to improving a pneumatic tire with a plurality of cells or sections, and to inflate the same. The invention of the '953 patent provides a tire casing of any well-known or preferred type and is suitably filled with “cells.” The tire casing may be rendered air tight by the placing of a strip in contact with the beads thereof, if necessary, or the usual inner tube may be arranged therein, and the cells held within this inner tube. The cells are provided with inwardly opening check valves, whereby when the air under suitable pressure is pumped into the tire casing through the usual valve, such air opens the check valves and passes to the interior of the cells. When the pressure within the tire casing, exteriorly of the cells, drops below that within the cells, the valves automatically close, thereby preventing the escape of pressure from the cells. It is thus seen that should the tire casing or one or more of the cells be punctured, the pressure within the remaining cells will maintain the tire casing inflated.

U.S. Pat. No. 6,896,020, as issued on May 24, 2005 to assignee TBDC, LLC, for a “Tire Inflated with a Plurality of Balls” relates to tires, particularly a pneumatic tire that is mounted on a safety rim and is inflated by a plurality of individual balls. This particular concept was disclosed by inventor Wade Summers, who conceived a tire assembly including a safety rim defining recesses on its inner surface, a tire including left and right edges, which are received in said recesses, and a plurality of inflated balls lying between the tire and the rim. The '020 patent discusses an alternative embodiment of the above-described concept, and specifically illustrated on the right. In that embodiment, the assembly is the same as in the preferred embodiment, except that an inner tube is inserted between the balls and the rim. The balls still have a diameter and extend radially to span the space from the tire edges to the tread area of the tire, so that there is only a single layer of balls. Here, the valve goes through the rim and into the interior of the tube. The inner tube is a standard inner tube, having a toroidal shape. This results in a hybrid-type of tire assembly. If the pressure inside the tube is low, the assembly functions in the same manner as the preferred embodiment, as if the tube were not present. As the pressure of the tube is increased, the tire assembly acquires a more rigid effect. The tube allows external adjustment for changes in load, terrain, or altitude.

U.S. Pat. No. 799,859 was issued on Sep. 19, 1905 to inventor Frank A. Magowan, covering an improved “Vehicle Tire.” The invention therein relates to a rubber or flexible tires for automobiles and other vehicles, and its object is to produce a tire that shall be equal or superior in point of resiliency to the ordinary pneumatic tire, and the tire will not deflate or lose resiliency when punctured. Therefore, the tire is configured so that it will retain such resiliency until worn out even though suffering many punctures. More specifically, the '859 patent claims a tire comprising a flexible tube filled with a mass of hollow soft-rubber “bullets,” each containing gas in a state of high compression, whereby each bullet is distended to such an extent that it conforms throughout to the adjoining bullets or wall of the tube. Further, the gas in each bullet is capable of expanding the bullet far beyond its normal capacity when the bullet is released from confinement. The above-mentioned bullets are small balls and are made of a good quality of rubber. The '859 patent also claims other tire configurations comprising of a tube filled with the soft-rubber bullets.

Lastly, U.S. Pat. No. 1,339,283, issued on May 4, 1920 to inventor James Albert Perkins, covers an “Inner Tube for Tires,” particularly the inner tubes for pneumatic tires. The invention of the inner tube therein aims to provide “sacks,” each being provided at the vicinity of its ends with connecting tubes. A lining or cushion is interposed between the inner tube and the casing, and said lining is provided with openings through which the connecting tubes may be passed so that the said connecting tubes may be readily joined with each other or disconnected from each other. Specifically, the '283 patent claims an inner tube, comprising of separate sack sections, and tubes connected with the end portions of the respective sections and adapted to connected together to provide communication between adjacent sections. Further, there is a continuous cushion disposed to lie against the inner surfaces of the sack sections and is provided with openings through which the tubes pass. Said cushion is held at intervals in raised supporting relation to the end portions of said sections, so as to hold same in required position, by the connected tubes.

### SUMMARY OF THE INVENTION

This invention provides a balanced non-deflatable vehicle tire providing balanced operation even after partial puncture, adjustment of overall air pressure, use of standard rimmed wheels, and the option of being retrofit into existing tires, by providing layers of puncture-resistant sheet material and pressurized-cell sheets, and an inner-tube to fill the remaining internal space and to adjust and apply balanced pressure internally.

### BRIEF DESCRIPTION OF DRAWINGS

Reference will now be made to the drawings, wherein like parts are designated by like numerals, and wherein:

FIG. 1 is an exploded view of the balanced non-deflatable vehicle tire of the invention;

FIG. 2 is a cross-section detail view of the balanced non-deflatable vehicle tire of the invention;

FIG. 3 is a section view of the balanced non-deflatable vehicle tire of the invention; and

FIG. 4 is a section and cutaway detail view of the pressurized-cell sheets of the balanced non-deflatable vehicle tire of the invention.

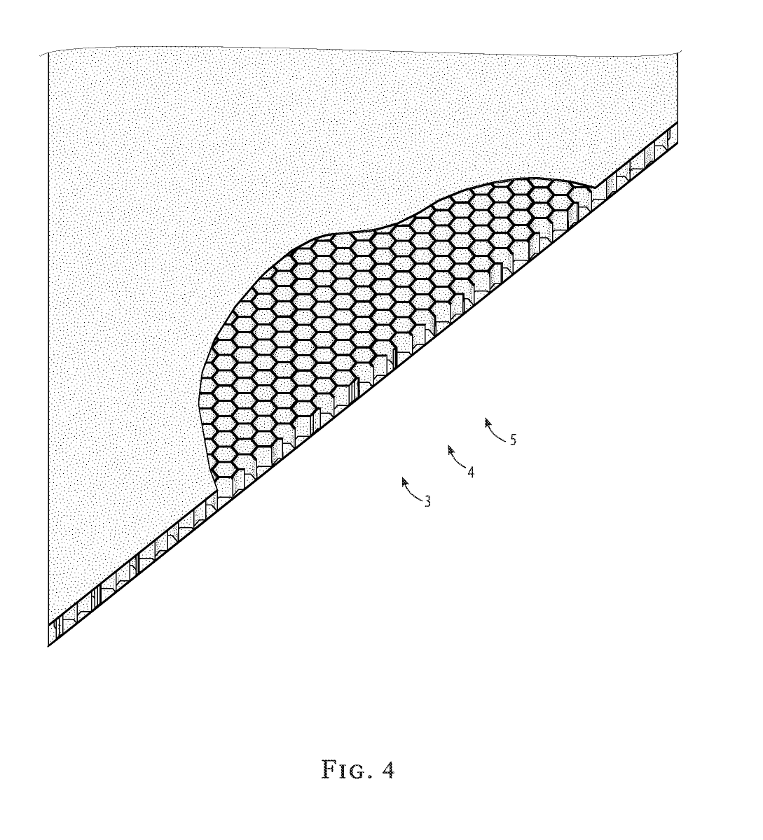

### DETAILED DESCRIPTION OF THE INVENTION

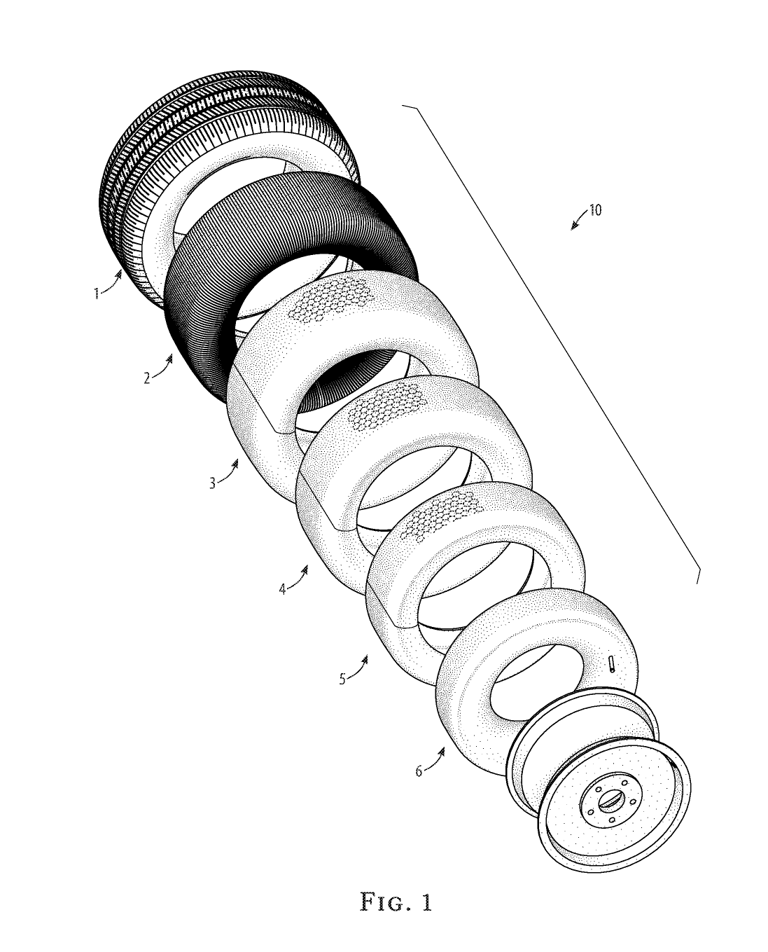

Referring to FIG. 1 and all of the figures generally, the balanced non-deflatable vehicle tire 10 of the invention is shown.

The balanced non-deflatable vehicle tire 10 optionally provides a vehicle tire 1, or may be implemented as a retrofit for an existing tire or type of tire.

The balanced non-deflatable vehicle tire 10 provides a layer of puncture-resistant sheet material 2, and at least two layers of pressurized-cell sheets 3, 4, 5. The number of layers can vary for different sizes and types of tires and for different anticipated uses and operating conditions. The illustrated embodiment provides three such layers, and is appropriate for standard-sized automobile tires in normal use.

The balanced non-deflatable vehicle tire 10 provides an inner-tube 6 mounted between the rimmed wheel and the layers of puncture-resistant sheet material 2, and pressurized-cell sheets 3, 4, 5. The inner-tube 6 presses the layers against the inside of the vehicle tire 1 evenly, which distributes the layers evenly and prevents material from moving around within the tire, which would negatively affect the balance of the tire in operation.

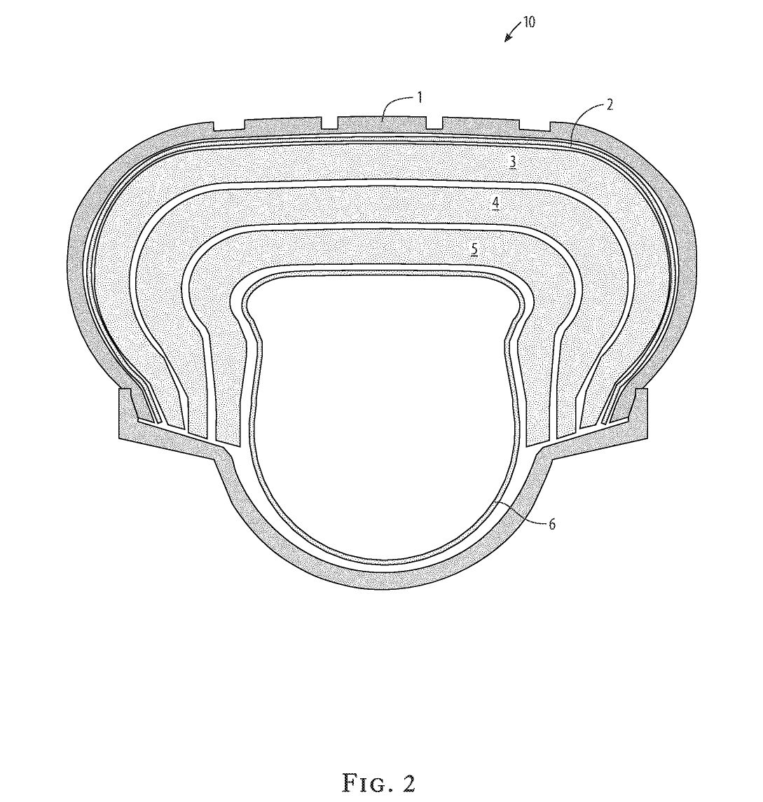

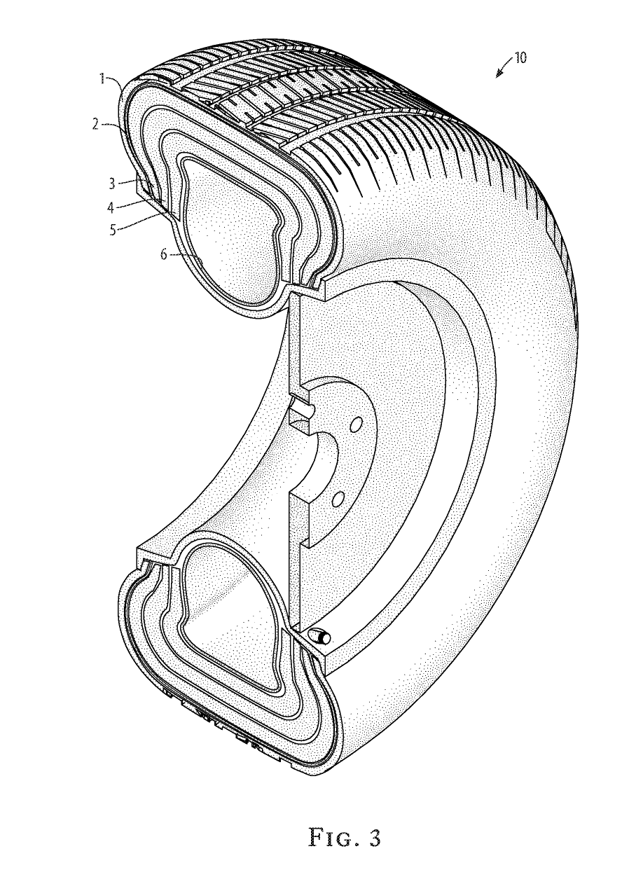

Referring to FIG. 2 & FIG. 3, under a constant and adjustable pressure from the inner-tube 6, the layers of puncture-resistant sheet material 2 and pressurized-cell sheets 3, 4, 5 are firmly held against the inside of the vehicle tire 1. The inner-tube 6, being flexible, can adapt to and fill in spaces or gaps created by the bending and folding of the layers. In the event of a partial puncture of enough adjacent cells to create a soft spot in the layers, the inner-tube 6 can fill into, and increase the supporting air pressure, behind such soft spots. Because the inner-tube 6 holds the layers in place, it is not necessary to glue or otherwise attach the layers to the inside of the tire 1. This configuration in turn provides easier and less expensive installation of the balanced non-deflatable vehicle tire 10 in a retrofit, and avoids the balance problems that would arise if glued components slipped out of place and became unequally distributed. The inner-tube 6 also provides the pressure necessary to maintain the seal between the tire and the rimmed wheel, and allows enough deflation to break that seal for removal of the tire from the rimmed wheel. Additionally, the balanced non-deflatable vehicle tire 10 can be installed on a wheel with the inner-tube 6 fully or partially deflated, and later pressurization of the inner-tube 6 will set the seal between the tire and the wheel. The inner-tube 6 provides an air valve that can be mounted as a replacement for an existing air valve, usually extending through the rimmed wheel.

With the balanced non-deflatable vehicle tire 10, the vehicle tire 1 mounted to the rimmed wheel does not need to be completely sealed or air tight in order to operate. Adjustment of the air pressure in the inner-tube 6 will set the overall air pressure in the tire, and can be adjusted to a higher or lower overall pressure, if needed, to best perform under various temperature, altitude, weather, and vehicle-load conditions. Small punctures in the vehicle tire 1 do not require sealing, because the tire does not have to be completely sealed. Larger punctures, such as cuts or gashes, are likely to ruin the structural integrity of the tire, causing it to eventually fail if it is left on the vehicle and subjected to a long period of further use. However, even with a larger puncture or cut, the balanced non-deflatable vehicle tire 10 will not significantly deflate beyond any individual cells that are damaged, and the inner-tube 6 will continue to exert the pressure needed to keep the tire 1 mounted to the rimmed wheel, which avoids the complete destruction which can happen to a tire if it is driven on with no pressure and is therefore not sealed to the wheel.

The puncture-resistant sheet material 2 should be a material or combination of materials that are relatively thin and flexible, but can still resist a puncturing force from an object such as a nail, screw, or other object likely to be encountered while driving. For example and without limitation, steel or metal in the form of chain-linked mail can be used. Manufactured specialty textiles, such as those known to be bullet proof or puncture resistant, can also be used. Preferably, the layer of puncture-resistant sheet material will protect all of the exposed surfaces of the tire, including sidewalls. The layer of puncture-resistant sheet material 2 may be configured as an accordion-folded layer, in order to provide extra material in the system, which would in turn allow an affected area of the material to expand and deform into an adjacent space.

Referring additionally to FIG. 5, the pressurized-cell sheets 3, 4, 5 are made up of adjacent pressurized cells constructed into a flexible or semi-flexible sheet. The pressurized-cell sheets can be made of a plastic or rubber material. In the illustrated embodiment, the cells have walls that are hexagonal, with top sheets and bottom sheets attached. The pressurized-cell sheet needs to have airtight cells. Standard barometric pressure is adequate. Increased pressure, if desired, can be achieved by sealing the pressurized-cell sheets under increased air pressure during manufacture. Gasses other than air, such as nitrogen, can be used. Preferably, the layers of pressurized-cell sheets 3, 4, 5 will protect all of the exposed surfaces of the tire, including sidewalls.

In use, the balanced non-deflatable vehicle tire can optionally be installed as a retrofit to an existing vehicle tire by providing a pre-assembled unit having the puncture-resistant sheet material 2, pressurized-cell sheets 3, 4, 5, and inner-tube 6 in the proper positions, with the inner-tube 6 deflated. Such a pre-assembled unit can be placed into an unmounted vehicle tire 1, with no need of gluing, attaching, or fine positioning. Optionally, the inner-tube 6 of this pre-assembled unit can be temporarily partially inflated in order to achieve an initial expansion of the unit into place inside the tire. Then, with the inner-tube 6 deflated, the vehicle tire 1 containing the pre-assembled unit can be mounted to the rimmed wheel in the usual way. Thereafter, the inner-tube 6 is inflated, which seals the tire in place on the wheel and pushes the other components into place inside the tire.

In use, the puncture-resistant sheet material 2 and pressurized-cell sheets 3, 4, 5 are kept in place by a combination of the centrifugal forces of the turning wheel and the pressure exerted by the inner-tube 6, which keeps the balanced non-deflatable vehicle tire 10 in balance. Although the components of the balanced non-deflatable vehicle tire 10 are held in place for balance purposes during smooth operation, the components are able to move enough to transfer force inside the component and outside between components in the event of a puncturing force. Each discrete unit or area of each component is designed to transfer puncturing force to and from adjacent units in a chain of transfers, which distributes a focused puncturing force across a large area. Also, failure of any discrete unit or area is incremental, and the tire remains supported by the rest of the components. The balanced non-deflatable vehicle tire 10 is designed so that even the failure of several adjacent units or areas will not affect the continued use of the tire. If a very large area is punctured and fails, the inner-tube 6 will expand into such an area, and air pressure can be added to the inner-tube 6 to compensate. Such conditions will probably affect the balanced operation of the tire, but will not prevent the tire from continuing to be used and driven on.

In use, when an object, such as a nail, penetrates the vehicle tire 1, it strikes the layer of puncture-resistant sheet material 2. If the nail is stopped by the layer of puncture-resistant sheet material 2, it is likely that the nail will deform the material enough to cause it to bulge into the layer of pressurized-cell sheet 3. The deformed puncture-resistant material will distribute and spread the nail's force to a certain extent, and the specific cell corresponding to the point of the nail might be able to absorb the force by bulging into the adjacent cells, which will further dampen or transfer such force. On the other hand, the force from the bulging puncture-resistant material might burst the specific cell corresponding to the point of the nail, or the nail might penetrate the puncture-resistant sheet material 2 and directly penetrate and burst the specific cell. In such an event the integrity and operation of the tire are essentially unaffected, because such a small percentage of the air-pressure support is lost. In the usual “slow leak” circumstances of a nail or screw being forced through the tire by continued driving, the puncturing force is small and spread out over time, and is therefore unlikely to deform or penetrate the layer of puncture-resistant sheet material 2 or to burst any cell in the outer layer of pressurized-cell sheet 3.

If the puncturing object, such as a nail, overcomes and penetrates the layers of the puncture-resistant sheet material 2 and pressurized-cell sheets 3, another layer of pressurized-cell sheets 4 lies underneath, and functions in the same way, but resisting a significantly lower and more diffuse force, because a significant amount of force will have been dissipated in overcoming the outer layers. Even if the second layer of pressurized-cell sheets 4 is overcome, the failure of one or a small number of cells will not affect the operation of the tire. Optionally, particularly in embodiments for larger tires or harsher hazards, a third layer of pressurized-cell sheet 5 can be provided, or even more layers can be provided.

Many other changes and modifications can be made in the system and method of the present invention without departing from the spirit thereof. I therefore pray that our rights to the present invention be limited only by the scope of the appended claims.

I claim:

1. A balanced non-deflatable vehicle tire, comprising:
(i) a vehicle tire having an outside and an inside, and having a circumference and a center;
(ii) a layer of puncture-resistant sheet material adapted for placement inside and conforming to the circumference of said vehicle tire;
(iii) at least two layers of pressurized-cell sheets adapted for placement inside and conforming to the circumference of said vehicle tire; and
(iv) an inner-tube adapted for placement inside and conforming to the circumference of said vehicle tire;
where said puncture-resistant sheet material and said pressurized-cell sheets are arrayed in layers proceeding from the inside circumferential surface of said vehicle tire;
where said inner-tube is arrayed inside said vehicle tire from the innermost layer of said pressurized-cell sheet toward the center of said vehicle tire;
where, in use, with said vehicle tire mounted upon a rimmed wheel, inflation of said inner-tube causes an expansion, producing an expanding force between the rimmed wheel and the layers of said puncture-resistant sheet material and pressurized-cell sheets, the expanding force pushing the layers of said puncture-resistant sheet material and pressurized-cell sheets into place along the inside surface of said vehicle tire;
where, in normal use, the layers of said puncture-resistant sheet material and said pressurized-cell sheets, and said inner-tube, are held firmly against the inside surface of said vehicle tire, promoting balanced rotation;
where, in use, upon encountering a puncturing object, said layer of puncture-resistant sheet material resists puncture and diffuses the puncturing force by reversible deformation into underlying layers, and the affected cells of said layers of pressurized-cell sheets resist puncture and resist bursting by reversible deformation into adjacent cells within the same layer and into underlying layers; and
where, upon the puncture or bursting of up to a small number of affected cells, support of the inside surface of said vehicle tire is continued by the remaining cells and by said inner-tube, and operation of said vehicle tire is not affected.

2. The balanced non-deflatable vehicle tire of claim 1, where said puncture-resistant sheet material further comprises a puncture-resistant fabric.

3. The balanced non-deflatable vehicle tire of claim 1, where said puncture-resistant sheet material further comprises a metal in sheet form.

4. The balanced non-deflatable vehicle tire of claim 1, where said puncture-resistant sheet material further comprises a metal in mesh form.

5. The balanced non-deflatable vehicle tire of claim 1, where said puncture-resistant sheet material further comprises a metal in chained metal form.

6. The balanced non-deflatable vehicle tire of claim 1, where said pressurized-cell sheets further comprise hexagonal cells.

7. The balanced non-deflatable vehicle tire of claim 1, where said inner-tube further comprises an air valve.

8. The balanced non-deflatable vehicle tire of claim 1, further comprising at least three layers of said pressurized-cell sheets.

9. The balanced non-deflatable vehicle tire of claim 1, further comprising at least four layers of said pressurized-cell sheets.

10. The balanced non-deflatable vehicle tire of claim 1, where said inner-tube is further adapted to provide for increased and decreased overall inflation pressure of said vehicle tire.

11. A balanced non-deflatable vehicle tire kit, for a vehicle tire having an outside and an inside, and having a circumference and a center, the non-deflatable vehicle tire kit comprising:
(i) a layer of puncture-resistant sheet material adapted for placement inside and conforming to the circumference of the vehicle tire;
(ii) at least two layers of pressurized-cell sheets adapted for placement inside and conforming to the circumference of the vehicle tire; and
(iii) an inner-tube adapted for placement inside and conforming to the circumference of the vehicle tire;
where said puncture-resistant sheet material and said pressurized-cell sheets are arrayed in layers proceeding from the inside circumferential surface of the vehicle tire;
where said inner-tube is arrayed inside the vehicle tire from the innermost layer of said pressurized-cell sheet toward the center of the vehicle tire;
where, in use, with the vehicle tire mounted upon a rimmed wheel, inflation of said inner-tube causes an expansion, producing an expanding force between the rimmed wheel and the layers of said puncture-resistant sheet material and pressurized-cell sheets, the expanding force pushing the layers of said puncture-resistant sheet material and pressurized-cell sheets into place along the inside surface of the vehicle tire;
where, in normal use, the layers of said puncture-resistant sheet material and said pressurized-cell sheets, and said inner tube, are held firmly against the inside surface of the vehicle tire, promoting balanced rotation;
where, in use, upon encountering a puncturing object, said layer of puncture-resistant sheet material resists puncture and diffuses the puncturing force by reversible deformation into underlying layers, and the affected cells of said layers of pressurized-cell sheets resist puncture and resist bursting by reversible deformation into adjacent cells within the same layer and into underlying layers;
where, upon the puncture or bursting of up to a small number of affected cells, support of the inside surface of the vehicle tire is continued by the remaining cells and by said inner-tube, and operation of the vehicle tire is not affected.

12. The balanced non-deflatable vehicle tire kit of claim 11, where said puncture-resistant sheet material further comprises a puncture-resistant fabric.

13. The balanced non-deflatable vehicle tire kit of claim 11, where said puncture-resistant sheet material further comprises a metal in sheet form.

14. The balanced non-deflatable vehicle tire kit of claim 11, where said puncture-resistant sheet material further comprises a metal in mesh form.

15. The balanced non-deflatable vehicle tire kit of claim 11, where said puncture-resistant sheet material further comprises a metal in chained metal form.

16. The balanced non-deflatable vehicle tire kit of claim 11, where said pressurized-cell sheets further comprise hexagonal cells.

17. The balanced non-deflatable vehicle tire kit of claim 11, where said inner-tube further comprises an air valve.

18. The balanced non-deflatable vehicle tire kit of claim 11, further comprising at least three layers of said pressurized-cell sheets.

19. The balanced non-deflatable vehicle tire kit of claim 11, further comprising at least four layers of said pressurized-cell sheets.

20. The balanced non-deflatable vehicle tire kit of claim 11, where said inner-tube is further adapted to provide for increased and decreased overall inflation pressure of the vehicle tire.
